(19) United States
(12) Patent Application Publication
(10) Pub. No.: US 2019/0015835 A1
(43) Pub. Date: Jan. 17, 2019

(54) PORTABLE THERMAL CYCLING DEVICE FOR QUICKLY CHANGING AND REGULATING TEMPERATURE

(71) Applicants: NATIONAL TAIWAN NORMAL UNIVERSITY, TAIPEI (TW); ACADEMIA SINICA, Tapei (TW)

(72) Inventors: TIEN-LI CHANG, TAIPEI CITY (TW); HSIEH-CHEN HAN, TAIPEI CITY (TW); ZHAO-CHI CHEN, TAIPEI CITY (TW); WEN-YI CHEN, TAINAN CITY (TW)

(21) Appl. No.: 15/668,914

(22) Filed: Aug. 4, 2017

(30) Foreign Application Priority Data
Jul. 17, 2017 (TW) 106123769

(51) Int. Cl. B01L 7/00; F28D 15/00; F28F 3/12

(52) U.S. Cl. CPC B01L 7/525; F28D 15/00; F28F 3/12; F28F 2260/02; B01L 2300/0816; B01L 2300/0887; B01L 2300/168; B01L 2300/1827; B01L 2300/0883; F28F 2255/20

(57) ABSTRACT

The present invention provides a portable thermal cycling device for quickly changing and regulating temperature, which is used for deoxyribonucleic acid (DNA) detection and amplification. The device adopts the concept of an electrical impedance method for detection, utilizes the spinning coating and electrospinning nanowires technologies to directly fabricate a thin film type thermal cycling device, and under the cooperation of a laser direct writing technology for patterning definition, enables the device to have the function of quickly raising/reducing temperature at one time for DNA amplification. Moreover, the present invention is provided with a micro-fluid channel and an electrical control module to adapt the reaction states of different biological DNA

### BACKGROUND OF THE INVENTION

### 1. Field of the Invention

The present invention relates to a thermal cycling device, in particular to a portable thermal cycling device for quickly changing and regulating temperature which has the function of quickly raising/reducing temperature at one time for DNA amplification.

### 2. Description of the Prior Art

At the first, the conventional PCR detection technology can only be applied in a PCR detection lab consisting of a plurality of large machines. With the improvement of machine fabrication process, a large single machine having a real time function is gradually developed out, and then a table-top machine which is popular currently is further developed. However, so far, the PCR detector is still a machine with a high unit price, and thus cannot be generalized in common families. And with the emergence of household health awareness of people, in order to achieve self-supervision and intensive care at home during daily life, the PCR detector shall be applied to discover gene defects, genetic diseases and acquired diseases at an early stage, even to reduce and prevent the derived diseases thereof in an epidemic prevention district and a district lacking resources. Therefore, how to achieve a PCR chip detection reaction platform having the characteristics of lightness, portability and quick detection has become a topic that all parties attempt to overcome.

### SUMMARY OF THE INVENTION

In order to solve the problems in the prior art, the present invention provides a portable thermal cycling device for quickly changing and regulating temperature, which is used for deoxyribonucleic acid (DNA) detection and amplification. The device of the present invention adopts an electrical impedance method for detection, utilizes spinning coating and electrospinning nanowires technologies to directly fabricate a thin film type thermal cycling device, and under the cooperation of a laser direct writing technology for patterning definition, enables the device to have the function of quickly raising/reducing temperature at one time for DNA amplification. Moreover, the present invention is provided with a micro-fluid channel and an electrical control module to adapt the reaction states of different biological DNA fluids, thus eliminating the problems of long time monitoring response and low resolution degree.

The present invention provides a portable thermal cycling device for quickly changing and regulating temperature, which is sequentially provided with a substrate, a temperature control layer, a sensing layer and a microchannel layer, Wherein the substrate is made from a transparent material with a high optical penetration rate such as glass or polyethylene terephthalate (PET), and is coated thereon with graphene with a spinning coating method; the temperature control layer is less than 10 μm thick, and is provided with a laser defined electrical impedance area, wherein the electrical impedance area comprises a first resistor area, a second resistor area, and a third resistor area, and is made from graphene, poly(3,4-ethylenedioxythiophene), or a doped composite of polystyrene sulfonic acid and graphene (PEDOT:PSS/graphene); the sensing layer is less than 1 μm thick, is provided with a nano-sensing area in an electrospinning nanowires defined network structure, and detects a DNA signal and a feedback error; the nano-sensing area comprises a first sensing area, a second sensing area, and a third sensing area; the nanowires are made from polyvinyl alcohol (PVA); the microchannel layer is provided with a picosecond laser defined microchannel area; the microchannel area comprises a first microchannel, a second microchannel, and a third microchannel, wherein the electrical impedance area, the nano-sensing area and the microchannel area have the same range, and are sequentially sealed together; furthermore, the electrical impedance area, the nano-sensing area and the microchannel area are integrally packaged, wherein the first resistor area, the first sensing area and the first microchannel have the same range, and are sequentially sealed to form a first temperature control area; the second resistor area, the second sensing area and the second microchannel have the same range, and are sequentially sealed to form a second temperature control area; and the third resistor area, the third sensing area and the third microchannel have the same range, and are sequentially sealed to form a third temperature control area; the first temperature control area, the second temperature control area and the third temperature control area can simultaneously generate three different temperatures, and the generated heat is transferred via the microchannel area of the microchannel layer to perform a polymerase chain reaction. Wherein a fluid inlet is disposed at one end of the microchannel area of the microchannel layer, and a fluid outlet is disposed on the other end of the microchannel area.

Wherein the ratio of the area of the electrical impedance area of the temperature control layer to the area of the substrate is 1:3; wherein the ratio of the area of the nano-sensing area of the sensing layer to the area of the electrical impedance area of the temperature control layer is 1:1; wherein the ratio of the area of the microchannel area of the microchannel layer to the area of the electrical impedance area of the temperature control layer is 1:1. The portable thermal cycling device for quickly changing and regulating temperature of the present invention utilizes the concept of electrical impedance method for detection, designs and fabricates a thin film type temperature control chip assembly, and integrates a surface nano-network sensing structure and a geometric structure for packaging the micro-fluid channel, so as to complete the detection of a fabricated micro-thermal cycling lab-on-a-chip. With regard to the materials, the present invention mainly adopts a novel material with a great dielectric constant. During the fabrication of the PCR chip, the temperature of the PCR is controlled by a micro-controller, and the detection result can also be displayed in real time via the integrated interface of the micro-controller. Therefore, the present invention not only can avoid the mutual contamination of samples, but can also be used for household detection, such that a patient can discover and effectively control a disease. To sum up, the portable thermal cycling device for quickly changing and regulating temperature of the present invention integrates the advantages of low cost, large scale production, fewer pre-treatment processes and the like, and becomes a new generation PCR detection chip.

### BRIEF DESCRIPTION OF THE DRAWINGS

FIG. 1 is an exploded schematic view of the portable thermal cycling device for quickly changing and regulating temperature according to the present invention.

FIG. 2 is a schematic view of the portable thermal cycling device for quickly changing and regulating temperature according to the present invention.

FIG. 3 is a schematic view of a heating controller of the portable thermal cycling device for quickly changing and regulating temperature according to the present invention.

FIG. 4 is a schematic view of one control circuit of the portable thermal cycling device for quickly changing and regulating temperature according to the present invention.

FIG. 5 is a schematic view of another control circuit of the portable thermal cycling device for quickly changing and regulating temperature according to the present invention.

FIG. 6 is a schematic view of further another control circuit of the portable thermal cycling device for quickly changing and regulating temperature according to the present invention.

FIG. 7 is a schematic view of yet another control circuit of the portable thermal cycling device for quickly changing and regulating temperature according to the present invention.

### SYMBOL DESCRIPTION OF MAIN ELEMENT

100 Substrate
200 Temperature control layer
300 Sensing layer
400 Microchannel layer
210 Electrical impedance area
211 First resistor area
212 Second resistor area
213 Third resistor area
310 Nano-sensing area
311 First sensing area
312 Second sensing area
313 Third sensing area
410 Microchannel area
411 First microchannel
412 Second microchannel
413 Third microchannel
421 Fluid inlet
422 Fluid outlet
510 First temperature control area
520 Second temperature control area
530 Third temperature control area
601 Block
602 Block
603 Block
604 Block
605 Block
606 Block
607 Block
608 Block

### DETAILED DESCRIPTION OF THE PREFERRED EMBODIMENT

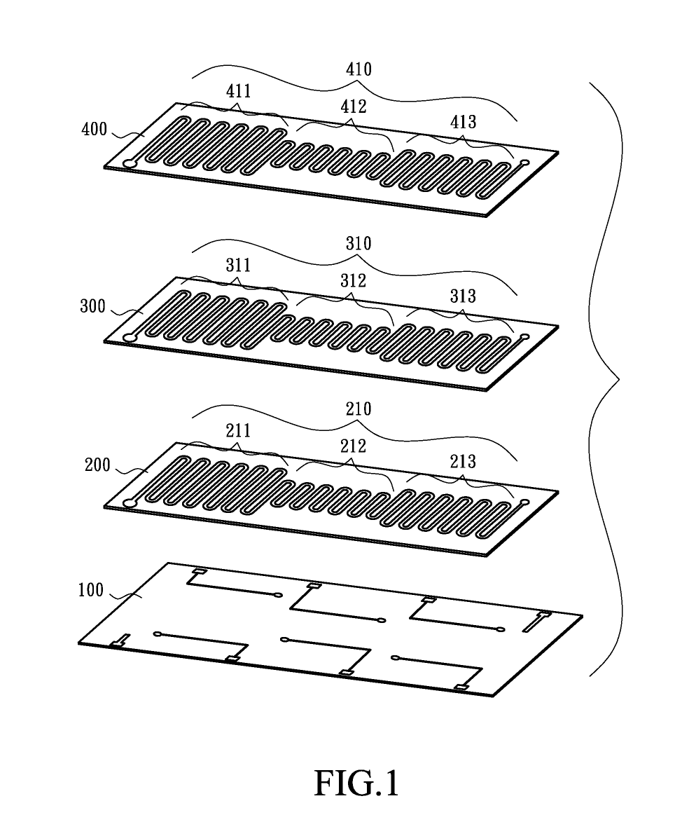

Please refer to FIG. 1 which is an exploded schematic view of the portable thermal cycling device for quickly changing and regulating temperature according to the present invention. As shown in FIG. 1, the device is sequentially provided with a substrate 100, a temperature control layer 200, a sensing layer 300 and a microchannel layer 400, wherein the substrate 100 is made from a transparent material with a high optical penetration rate such as glass or polyethylene terephthalate (PET), and is coated thereon with graphene with a spinning coating method. The temperature control layer 200 is less than 10 μm thick, and is provided with a laser defined electrical impedance area 210, wherein the electrical impedance area 210 is made from graphene, poly (3, 4-ethylenedioxythiophene), or a doped composite of polystyrene sulfonic acid and graphene (PEDOT:PSS/graphene), and comprises a first resistor area 211, a second resistor area 212, and a third resistor area 213. The sensing layer 300 is less than 1 μm thick, is provided with a nano-sensing area 310 in an electrospinning nanowires defined network structure, and detects a DNA signal and a feedback error, wherein the nano-sensing area 310 comprises a first sensing area 311, a second sensing area 312, and a third sensing area 313; the nanowires are made from polyvinyl alcohol (PVA). The microchannel layer 400 is provided with a picosecond laser defined microchannel area 410, wherein the microchannel area 410 comprises a first microchannel 411, a second microchannel 412, and a third microchannel 413.

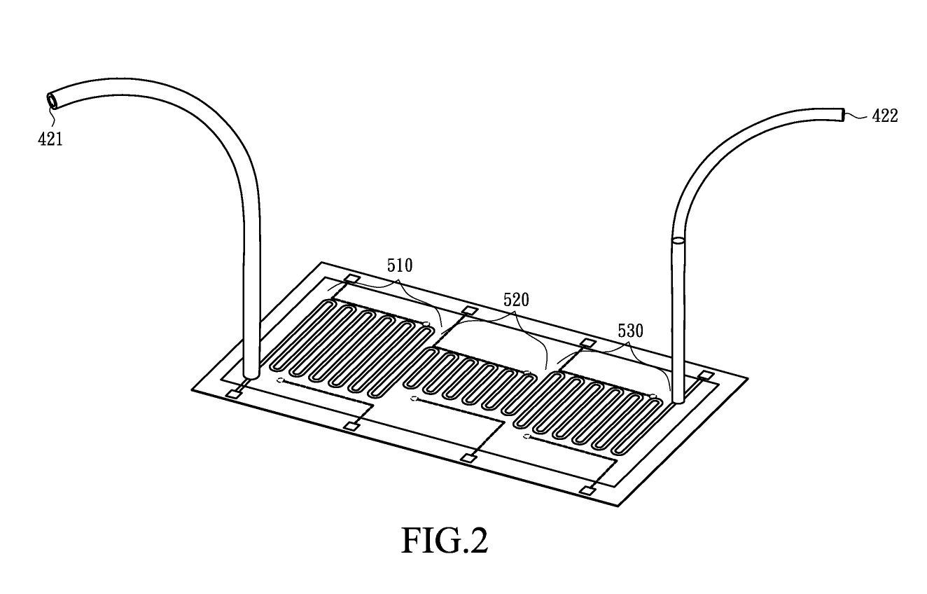

Please refer to FIG. 2 which is a schematic view of the portable thermal cycling device for quickly changing and regulating temperature according to the present invention. As shown in FIG. 2, the ratio of the area of the electrical impedance area 210 of the temperature control layer 200 to the area of the substrate 100 is 1:3; the ratio of the area of the nano-sensing area 310 of the sensing layer 300 to the area of the electrical impedance area 210 of the temperature control layer 200 is 1:1; and the ratio of the area of the microchannel area 410 of the microchannel layer 400 to the area of the electrical impedance area 210 of the temperature control layer 200 is 1:1. Therefore, the electrical impedance area 210, the nano-sensing area 310 and the microchannel area 410 have the same range, are sequentially sealed and integrally packaged; in other words, wherein the first resistor area 211, the first sensing area 311 and the first microchannel 411 have the same range, and are sequentially sealed to form a first temperature control area 510; the second resistor area 212, the second sensing area 312 and the second microchannel 412 have the same range, and are sequentially sealed to form a second temperature control area 520; and the third resistor area 213, the third sensing area 313 and the third microchannel 413 have the same range, and are sequentially sealed to form a third temperature control area 530. Moreover, a fluid inlet 421 is disposed at one end of the microchannel area 410 of the microchannel layer 400, and a fluid outlet 422 is disposed on the other end of the microchannel area 410. A fixed quantity of fluid is injected from the fluid inlet 421 at a constant speed via a syringe under the cooperation of a valveless controller, flows out from the fluid outlet 422, and is received in a carrier.

Wherein the first temperature control area 510, the second temperature control area 520 and the third temperature control area 530 can simultaneously generate three different temperatures, and respectively maintain the temperatures to be constant; and the generated heat is transferred via the microchannel area of the microchannel layer to perform a polymerase chain reaction. Generally speaking, the first temperature control area 510 is maintained at 98° C.; the second temperature control area 520 is maintained at 67.5° C.; the third temperature control area 530 is maintained at 72° C.; and the error of each temperature control area is in ±1-2° C.

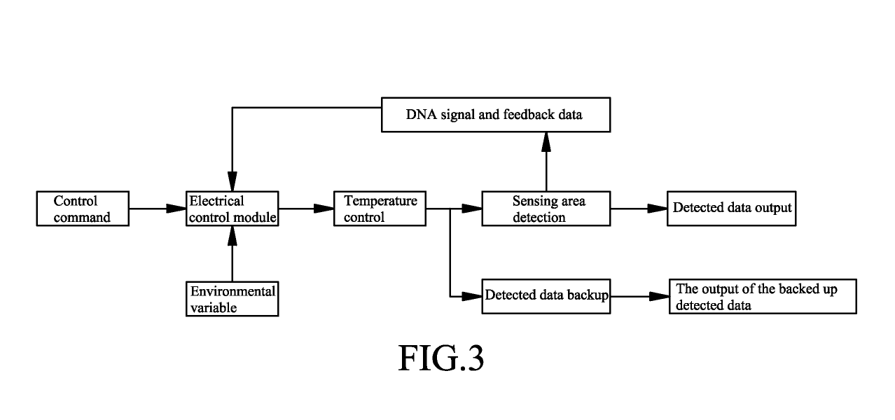

Please refer to FIG. 3 which is a schematic view of a heating controller of the portable thermal cycling device for quickly changing and regulating temperature according to the present invention. As shown in FIG. 3, when an electrical control module receives a control command or an environmental variable, the electrical control module activates the first temperature control area, the second temperature control area and the third temperature control area for temperature control, and respectively utilizes the first resistor area, the second resistor area and the third resistor area to heat and control the temperatures of the fluids inside the first microchannel, the second microchannel and the third microchannel. Furthermore, the electrical control module receives detected data from the first sensing area, the second sensing area and the third sensing area, backs up and outputs the detected data, wherein the detected data is the DNA signal and the feedback error.

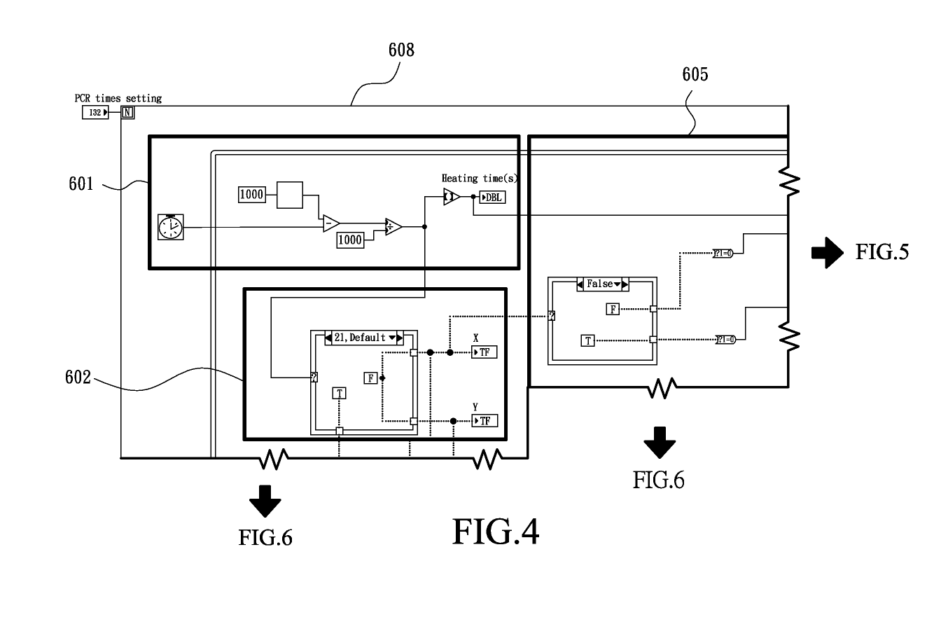

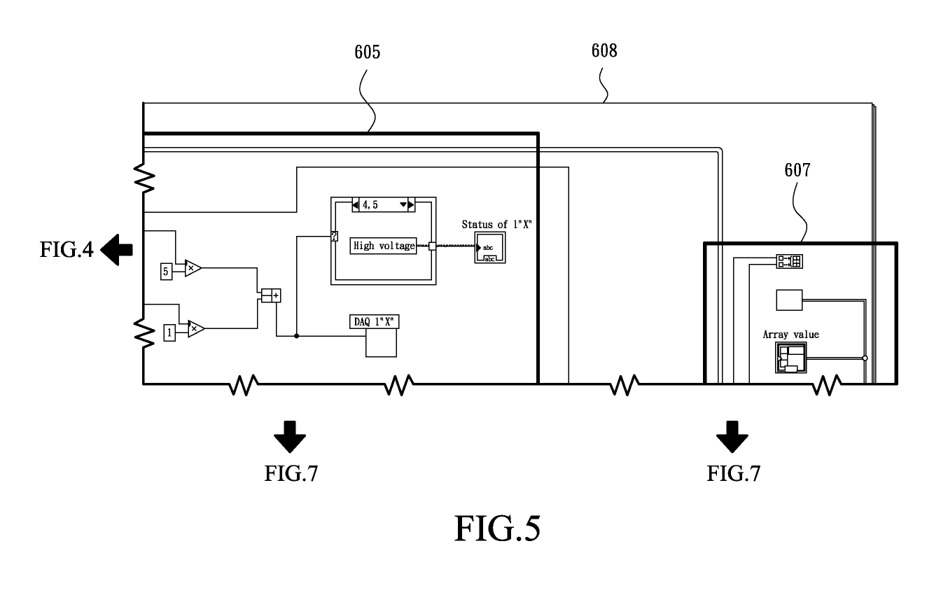

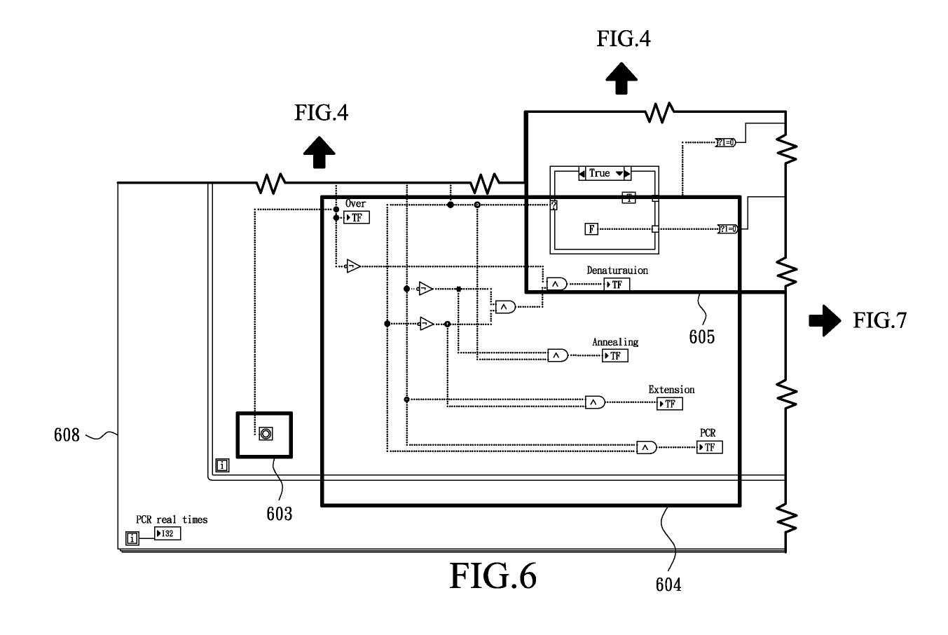

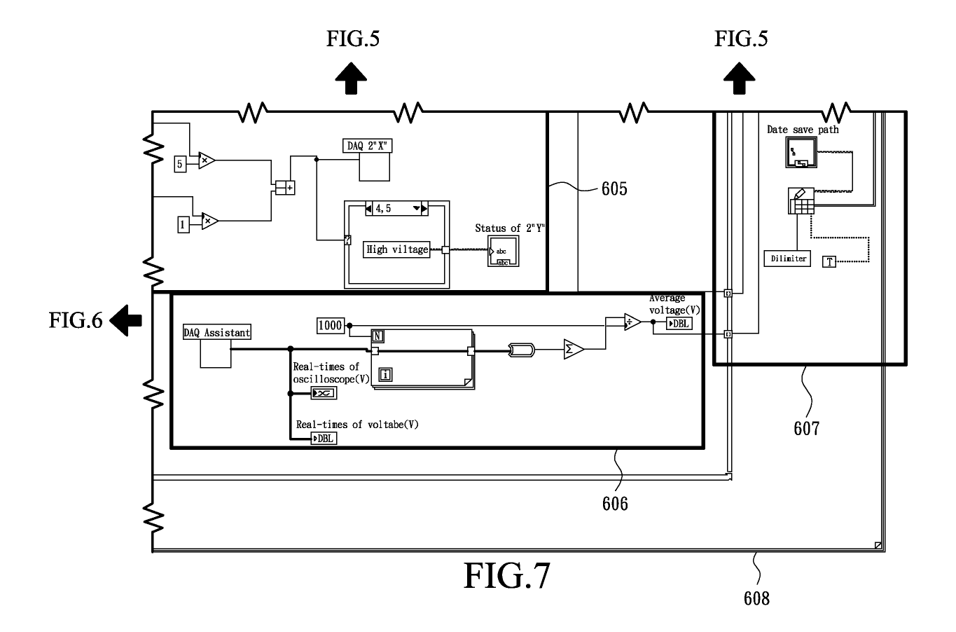

Please refer to FIG. 4-7 which are schematic views of control circuits of the portable thermal cycling device for quickly changing and regulating temperature according to the present invention. As shown in FIG. 4-7, a block 601 is a timer which controls to execute one step per second; a block 602 is an FUC which determines an action according to a second level time period, for example, in the time period 0-5 s, X=0, Y=0, and in the time period 6-10 s, X=0, Y=1; a block 603 is a time stopper; a block 604 is a digital LED for displaying a state; a block 605 is used for outputting the state; a T/F controls four I/O outputs, comprising four states 00, 01, 10 and 11, wherein each state represents one STEP; a block 606 is a practically measured output potential; a block 607 is a writing device; and a block 608 is a cycle, Wherein each PCR reaction consists of 15-20 cycles, and each cycle comprises the following three steps: the first step is denaturation, raising the temperature to 98° C.±1-2° C., and maintaining the temperature for 20-40 s; the second step is annealing, reducing the temperature to 67.5° C.±1-2° C., and maintaining the temperature for 1 min; and the third step is extension, re-raising the temperature to 72° C.±1-2° C., maintaining the temperature for 2 min, and then going back to the first step (equivalent to the beginning of the next cycle). The PCR reaction will be completed after such a process is repeated for 15-20 times.

What is claimed is:

1. A portable thermal cycling device for quickly changing and regulating temperature, comprising:
A substrate, made from a transparent material with a high optical penetration rate, and coated with graphene;
A temperature control layer, disposed on one side of the substrate, and provided with a laser defined electrical impedance area, wherein the electrical impedance area comprises a first resistor area, a second resistor area, and a third resistor area;
A sensing layer, disposed on one side of the temperature control layer, and provided with a nanowires defined nano-sensing area, wherein the nano-sensing area comprises a first sensing area, a second sensing area, and a third sensing area; and
A microchannel layer, disposed on one side of the sensing layer, and provided with a picosecond laser defined microchannel area, wherein the microchannel area comprises a first microchannel, a second microchannel, and a third microchannel; and
The electrical impedance area, the nano-sensing area and the microchannel area have the same range, and are sequentially sealed together.

2. The portable thermal cycling device for quickly changing and regulating temperature as claimed in claim 1, wherein the transparent material with a high optical penetration rate for making the substrate is glass or polyethylene terephthalate (PET).

3. The portable thermal cycling device for quickly changing and regulating temperature as claimed in claim 1, wherein the electrical impedance area of the temperature control layer is made from graphene, poly(3,4-ethylenedioxythiophene), or a doped composite of polystyrene sulfonic acid and graphene (PEDOT:PSS/graphene).

4. The portable thermal cycling device for quickly changing and regulating temperature as claimed in claim 1, wherein thickness of the temperature control layer is less than 10 μm.

5. The portable thermal cycling device for quickly changing and regulating temperature as claimed in claim 1, wherein the ratio of the area of the electrical impedance area of the temperature control layer to the area of the substrate is 1:3.

6. The portable thermal cycling device for quickly changing and regulating temperature as claimed in claim 1, wherein the nanowires of the sensing layer are in an electrospinning nanowires defined network structure.

7. The portable thermal cycling device for quickly changing and regulating temperature as claimed in claim 1, wherein the nanowires of the sensing layer are made from polyvinyl alcohol (PVA).

8. The portable thermal cycling device for quickly changing and regulating temperature as claimed in claim 1, wherein the ratio of the area of the nano-sensing area of the sensing layer to the area of the electrical impedance area of the temperature control layer is 1:1.

9. The portable thermal cycling device for quickly changing and regulating temperature as claimed in claim 1, wherein thickness of the sensing layer is less than 1 μm.

10. The portable thermal cycling device for quickly changing and regulating temperature as claimed in claim 1, wherein a fluid inlet is disposed at one end of the microchannel area of the microchannel layer, and a fluid outlet is disposed on the other end of the microchannel area.

11. The portable thermal cycling device for quickly changing and regulating temperature as claimed in claim 1, wherein the ratio of the area of the microchannel area of the microchannel layer to the area of the electrical impedance area of the temperature control layer is 1:1.

12. The portable thermal cycling device for quickly changing and regulating temperature as claimed in claim 1, wherein the electrical impedance area, the nano-sensing area and the microchannel area are integrally packaged.

13. The portable thermal cycling device for quickly changing and regulating temperature as claimed in claim 1, wherein the first resistor area, the first sensing area and the first microchannel have the same range, and are sequentially sealed to form a first temperature control area; the second resistor area, the second sensing area and the second microchannel have the same range, and are sequentially sealed to form a second temperature control area; and the third resistor area, the third sensing area and the third microchannel have the same range, and are sequentially sealed to form a third temperature control area.
